(19) United States
(12) Patent Application Publication
(10) Pub. No.: US 2011/0016781 A1
(43) Pub. Date: Jan. 27, 2011

(54) Float operated plant watering device

(76) Inventor: Michael T. Richardson, Ellerbe, NC (US)

Correspondence Address: THE INVENTORS NETWORK, INC., 332 ACADEMY STREET, CARNEGIE, PA, 15106, US

(21) Appl. No.: 12/460,865

(22) Filed: Jul. 27, 2009

(51) Int. Cl. A01G 29/00

(52) U.S. Cl. 47/48.5

(57) ABSTRACT

A plant watering system for providing water to any type of plant as the water is needed by the plant and which is interconnected to any standard water supply includes a water reservoir placed about ten inches from the plant's root system having an internal float system for regulating the amount of water contained within the water reservoir and the reservoir having a downwardly projecting discharge tube completely buried in the soil and the discharge tube having an aperture at its lower end through which water is automatically dispersed for permeation through the soil to the root system controlled and regulated by the float system whereby the float system keeps the reservoir full without wasting water.

### FIELD OF THE INVENTION

The present invention pertains to irrigation and watering devices for shrubs, plants, trees, vineyards, fruits, etc., and more particularly pertains to a plant watering device that automatically disperses water to the root system of the plant as needed by the plant.

### BACKGROUND OF THE INVENTION

A number of things are required for any kind of plant life to successfully grow, blossom, reach maturity, provide shade, cover, aesthetic beauty, and sprout fruit or vegetables all for the benefit of both animal species and humanity. Certainly the basics such as adequate sunlight, freedom from diseases, insects, and pests, and the appropriate growing season are essential for proper plant growth. Perhaps most important of all is an adequate, available, appropriate amount of water as needed for that particular plant; neither too little which will stunt and kill plant growth nor too much which will also have the same effect. Since many plants, bushes, shrubs, flowers, and trees are of domesticate varieties and species, they require watering by human directed and operated means and methods. Such watering means and methods can encompass everything from hand watering plants from pitchers filled up at the kitchen sink to the use of complex irrigation systems that water many hundreds of acres of plants, bushes, trees, orchards, vineyards, landscaping flora, crops, etc. A number of impediments and hindrances are presented to the individual for providing the proper amount of water to plants, shrubs, trees, etc. on a residential or small scale. The individual must first remember to water the plants on a regular basis which, given the daily distractions of modern life is not always easy. Then the individual must not under water or, conversely, over water the plants, shrubs, flowers, trees, etc. Also, the watering of the plant(s) must be done in such a way that the water doesn't sit on the top of the soil adjacent and about the plant and evaporate before the water can sink into the soil; and, contrawise, the water must not permeate the soil in such a way that the water doesn't reach the root system. Therefore, systems or methods have been devised to water plants, trees, shrubs, flowers, orchards, vineyards, crops, etc. in a regular and systematic manner.

For example, the Bates patent (U.S. Pat. No. 3,754,352) discloses a watering device for plants that includes a reservoir and a chamber with the chamber located below ground so that water flows from the reservoir into the chamber when water drops below the level of a supply pipe connecting the chamber to the reservoir.

The Reese patent (U.S. Pat. No. 4,060,991) discloses a sub-surface irrigation method and apparatus wherein all the major components are buried beneath the ground surface.

The Scragg patent (U.S. Pat. No. 4,499,686) discloses a plant water device that includes a water holding receptacle and a porous tube inserted into the ground so that water held within the receptacle percolates through the tube into the ground.

The Moss patent (U.S. Pat. No. 4,509,692) discloses a drip or trickle irrigation system that includes a variable orifice that varies the amount of fluid flow in concert with variations in pressure of the fluid head and water supply pressure.

The Sibbel patent (U.S. Pat. No. 4,685,827) discloses a watering system that includes a plurality of watering cylinders located adjacent the plant roots with the watering cylinders connected to a water supply unit through a closed pipeline.

The Tsurata patent (U.S. Pat. No. 5,020,939) discloses an irrigation method and apparatus that includes interconnected components for drip irrigation of farms and potted plants.

The Hirahara patent (U.S. Pat. No. 5,364,034) discloses a controlled low volume irrigation system that can be used for batch or continuous time-dependent watering by the conveyance of water through holes of a plant water tubes and to the plant clusters.

The Nalbandian et al. patent (U.S. Pat. No. 6,237,283 B1) discloses a linked-sub irrigation reservoir system that is disposed within an absorbent soil medium beneath one or more plants.

The Shaw patent (U.S. Pat. No. 6,418,664 B1) discloses a self-watering plant pot that includes a water refill light that signals when the water reservoir and/or the plant food needs refilled.

The Atkinson et al. patent (U.S. Pat. No. 6,848,483 B1) discloses a liquid level-maintaining device that is especially suited for a plant container with a reservoir of water below the plant.

The Chen patent (U.S. Pat. No. 7,222,454 B1) discloses an apparatus and method for watering a houseplant and includes an automated plant-watering device that includes an automated timer for regulating the transference of water between planters.

Nonetheless, despite the ingenuity of the above devices, there remains a need for a float-operated plant watering device that maintains the distribution of water to the root system of a plant without wasting water.

### SUMMARY OF THE INVENTION

The present invention comprehends an inexpensive, easy to operate, easy to assemble and disassemble float operated plant watering device that conserves water by dispersing to the root system of the plant only the amount of water needed by that plant at any given time thereby preventing water from being wasted.

The float operated plant watering device can be interconnected to any standard water supply line such as an outdoor hose bib or outdoor spigot and includes a ground mounted water cylinder or reservoir having an upper end, a lower end, and a continuous cylindrical sidewall. A removable cap closes the upper end and laterally projecting from the sidewall adjacent the upper end is a water inlet fitting to which the end of the water hose is connected for supplying water to the internal chamber or cavity of the water reservoir. Disposed within the internal cavity of the water reservoir is a float system that includes a float switch that is pivotally mounted to an inlet tube and is responsive to and regulates that amount of water flowing into the water reservoir and the water level within the water reservoir. Thus, a flow of water is maintained to the root system but only as needed by the plant and when the water reservoir is filled with water, the float switch pivots to the close position thereby preventing water from the supply line from entering the water reservoir. As the root system absorbs water discharged from the aperture of the discharge stem, the water level in the water reservoir drops causing the float switch to pivot to the open position allowing water from the water supply line to enter and begin to fill the water reservoir.

It is an objective of the present invention to provide a float operated plant watering device that automatically disperses water into the root system of the plant as needed by the plant.

It is another objective of the present invention to provide a float operated plant watering device that includes a float system having a float switch that keeps the tank or reservoir of the device full without wasting water.

It is still yet another objective of the present invention to provide a float operated plant watering device that is designed and adapted to efficiently water landscaping.

It is still yet a further objective of the present invention to provide a float operated plant watering device that can be interconnected to any standard water supply such as a standard outdoor hose bib or can be directly connected to the underground plumbing.

Still another objective of the present invention is to provide a float operated plant watering device that conserves water by only delivering the amount of water that the plant requires at any given time.

Still yet another objective of the present invention is to provide a float operated plant watering device that maintains itself and uses less water from the water source for watering the root system of plants, shrubs, trees, crops, etc.

Yet another objective of the present invention is to provide a float operated plant watering device that is inexpensive, easy to set up and disassemble, and maintains itself.

These and other objects, features, and advantages will become apparent to those skilled upon a perusal of the following detailed description read in conjunction with the accompanying drawing figures and appended claims.

### BRIEF DESCRIPTION OF THE DRAWINGS

FIG. 1 is a perspective view of the float operated plant watering device of the present invention illustrating the water tank or reservoir of the system and the water supply line in flow registration therewith;

FIG. 2 is a side elevational view of the float operated plant watering device of the present invention taken along lines 2-2 of FIG. 1 illustrating the disposition of the float switch that allows water from the supply line to enter the reservoir;

FIG. 3 is a side elevational view of the float operated plant watering device of the present invention taken along line 2-2 of FIG. 1 illustrating the disposition of the float switch when water completely fills the water reservoir and no water is allowed to enter the water reservoir;

FIG. 4 is a side elevational view of the float operated plant watering device of the present invention illustrating the disposition of the device in its operative state for providing water to the root system of the plant as needed by the plant; and

FIG. 5 is a top plan view of the float operated plant watering device of the present invention illustrating the spatial distance and location of the water reservoir with respect to the root system of the plant.

### DETAILED DESCRIPTION OF THE PREFERRED EMBODIMENT

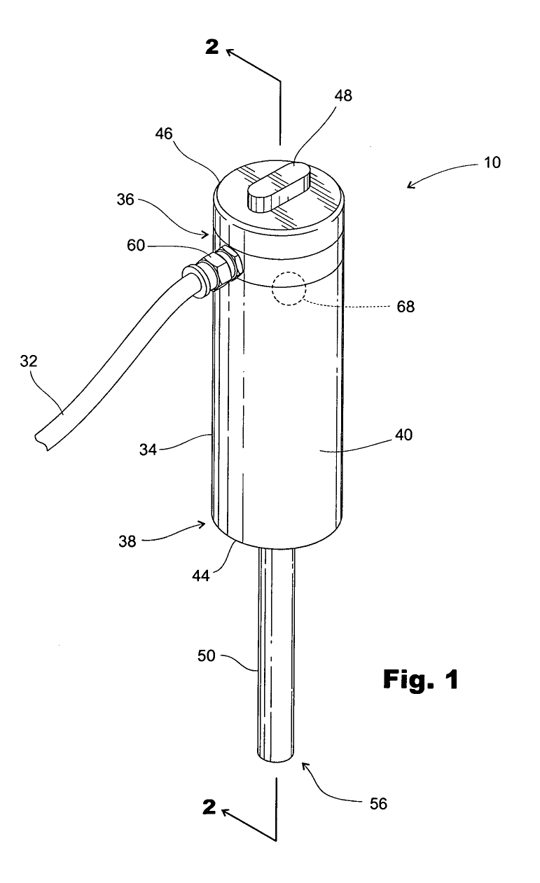

Illustrated in FIGS. 1-5 is a float operated plant watering device 10 that provides water 12 to a plant only as needed by the plant and thus both avoids wasting water and conserves water. The float operated watering device 10 thus provides water to the plant only as needed for that given time period by the interaction of a float switch within the device 10 and the specific level of water the device 10 holds. The float operated watering device 10 can be used for a regulated discharge of water to plants of any kind ranging from flowers, shrubs, bushes, trees, garden fruits and vegetables, landscaping flora, etc.; and while the float operated device 10 is designed for small-scale use it can be scaled up for larger plantings and large scale watering operations.

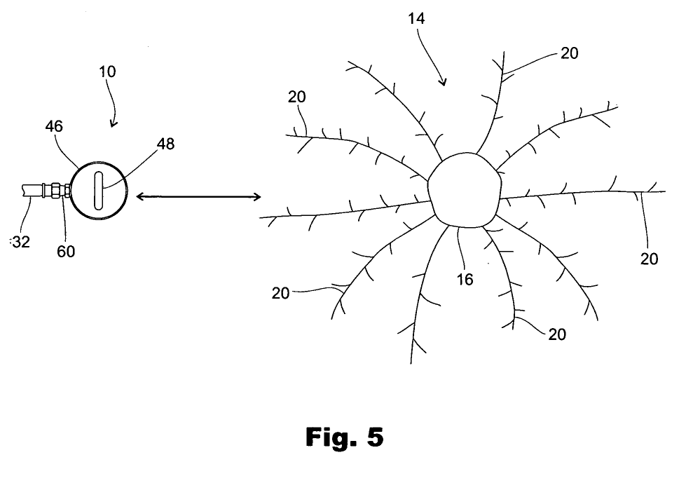

Shown in FIGS. 4 and 5 is representative plant 14 with the trunk 16 growing upward from the ground 18 and a root system 20 extending in all directions throughout the soil 22. The device 10 is inexpensive, easy to set, operate, and take down and store when desired, and is made from common materials so as to reduce the cost. The device 10 is placed approximately 10 inches from the root system 20 and is set in about a four inch diameter hole with one part of the device 10 extending down into the ground 18 about one foot deep. As shown in FIG. 4, the device 10 can be connected to any standard water supply source or line such as an outdoor hose bib or spigot 24 with the outdoor spigot 24 of FIG. 4 mounted to and extending from the wall 26 of the dwelling. The outdoor spigot 24 includes an open/close hand valve 28 and attached to the end or mouth of the discharge port 30 is one end of a standard water hose or tubing 32 that extends to and is secured to the device 10.

As shown in FIGS. 1-5, the device 10 includes an elongated cylindrical tubular-shaped water tank or reservoir 34. The water tank 34 includes an upper end 36, a lower end 38, and a continuous sidewall 40 that extends between the upper end 36 and the lower end 38 and which defines an internal water holding chamber 42. A circular floor 44 further defines the lower end 38 while a cap 46 closes off the upper end 36; and the cap 46 is removably securably to the upper end 36 by any conventional type of securement means such as a press fit connection or by an interengagable threaded connection. A projection 48 on the top of the cap 46 allows the individual to manually rotate or lift the cap 46 up off the water tank 34 for removal therefrom.

As shown in FIGS. 1-4, integrally attached to and extending downwardly from the floor 44 of the water tank 34 is a slender, elongated discharge stem or pipe 50. The stem 50 has an inner open end 52 that registers with the internal chamber 42 of the tank 34, and the stem 50 includes an inner bore 54 through which the water 12 flows for eventual discharge from the device 10 to the root system 20 of the plant 14. The stem 50 is approximately one foot long and concentric to and with the longitudinal axis of the water tank 34 and the stem 50 includes a lower stem end 56 that has a discharge or drain hole or aperture 58 having a diameter of at least 5/64 of an inch and through which water 12 flows for absorption by the root system 20 of the plant 14. The device 10 is situated as shown by the arrow in FIG. 5 so that the drain hole 58 at the lower stem end 56 of the stem 50 faces and opens toward the root system 20. As shown in FIG. 4, when the device 10 is disposed in its operative position for automatically providing water 12 to the root system 20 as needed by the plant 14, the stem 50 is fully buried within the ground 18.

Illustrated in FIGS. 1-4 is a water inlet fitting or water inlet 60 that laterally projects from the sidewall 40 adjacent the upper end 36 thereof and is in flow registration with the internal chamber 42 of the tank 34. The opposite end of the water supply line or hose 32 is removably attachable to the water inlet 60 so that water 12 from the source can flow, as needed and selectively, through the line 32, through the water inlet 60 and into the water tank 34 when the water is turned on from the source.

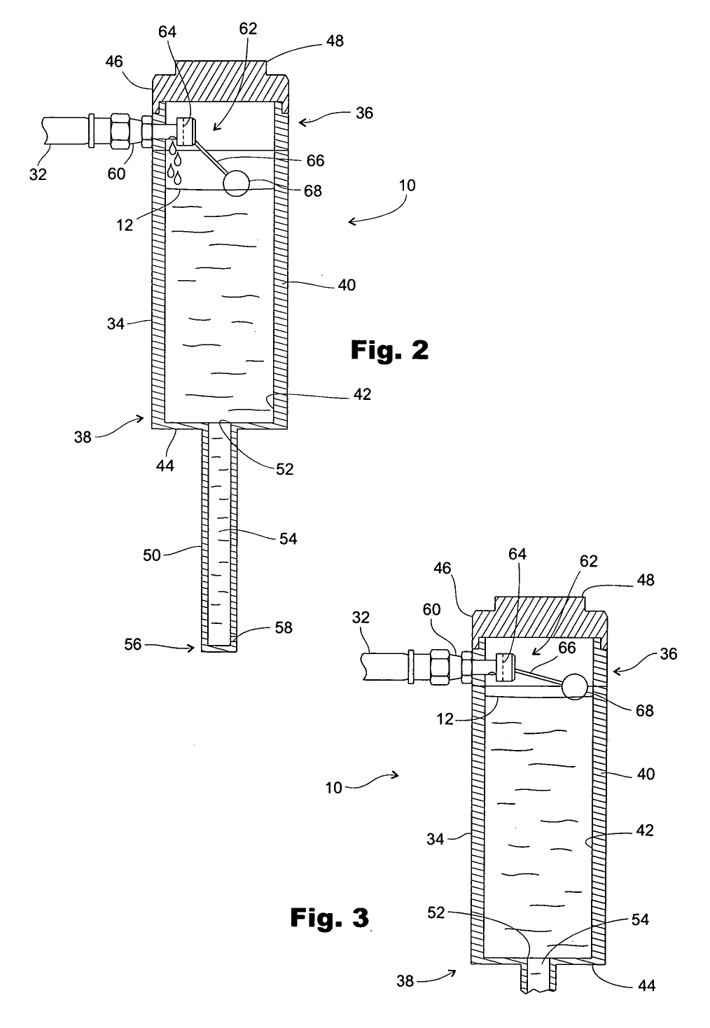

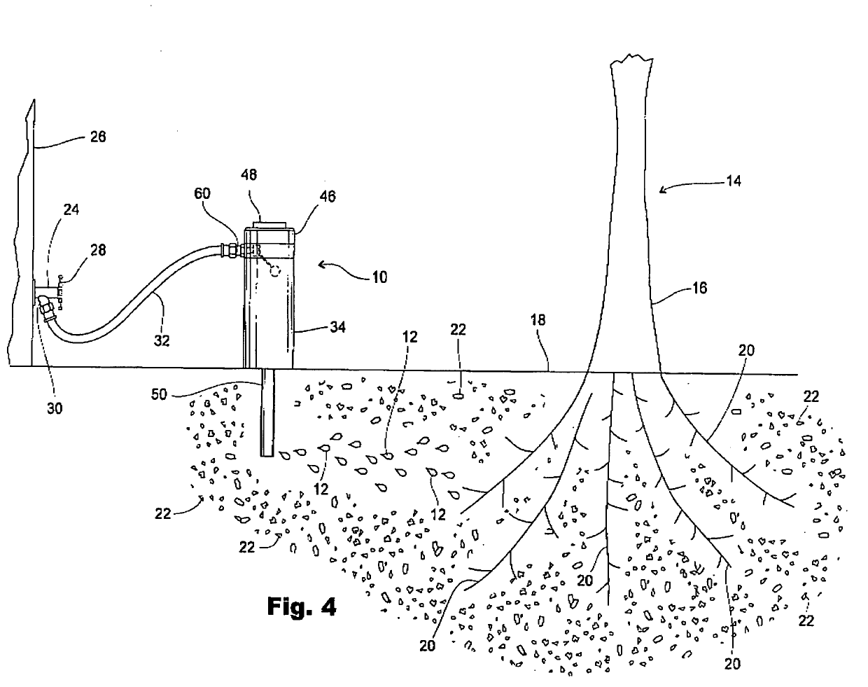

Illustrated in FIGS. 2 and 3 is a float switch 62 that is located within the internal chamber 42 and that both regulates and is responsive to the level (amount) of water 12 in the water tank 34. The float switch 62 includes an open/close valve 64, an arm 66 interconnected to the valve 64, and a float ball 68 connected to the arm 66 and that rests on the surface of the water 12 within the water tank 34. The arm 66 and float ball 68 pivot—rise and fall—concomitant with the rising or falling of the level of water 12 within the water reservoir 34, and this pivotal action causes the valve 64 of the float switch 62 to either open or close. When the valve 64 is closed water 12 from the supply source cannot enter the internal chamber 42 of the water tank 34, and when the valve 64 is in a range of open positions, water 12 from the supply source can enter and slowly fill the internal chamber 42 of the water tank 34. FIG. 2 shows the disposition of the arm 66 and the float ball 68 for opening the float valve 64 and letting water 12 slowly enter the internal chamber 42 of the water tank 34 while FIG. 3 shows the disposition of the arm 66 and float ball 68 when the level of water 12 is at its highest thus filling the internal chamber 42 of the tank 34 and disposing the arm 66 and float ball 68 to pivot and shut off the float valve 64 so that no water 12 from the supply source can enter the internal chamber 42 of the water reservoir 34. FIG. 4 illustrates the device 10 in its operative disposition with the stem 50 buried within the ground 18, the discharge hole 58 facing the root system 20 of the plant 14, the water tank 34 extending above ground 18, and the water supply hose or conduit 32 interconnected between the water source and the water inlet 60 projecting from the upper end 36 of the water tank 34. For clarity water 12—and the level of water 12—isn't shown within the water tank 34 but the components of the float switch 62 are and thus the arm 66 and float ball 68 are shown pivoted to a disposition within the tank 34 that allows water 12 to flow down through the bore 54 of the stem 50 and out the discharge hole 58 for absorption by the root system 20 of the plant 14. Thus, water 12 stored or held within the water reservoir 34 is discharged to the root system 20 of the plant 14 automatically and without operator intervention, and water 12 is dispersed to the root system 20 only as needed by the plant 12 thereby conserving water 12 as the float switch 62 continuously operates to maintain a full level or amount of water 12 within the water tank 34 and thus avoids wasting water.

It will be understood that only the best known embodiments of the invention have been illustrated and described in detail herein, and the invention is not limited thereto or thereby but may be subject to modifications, alterations, and variations, without departing from the scope of the invention as set forth in the detailed description and the claims appended hereto.

I claim:

1. A float operated plant watering device placed on the ground and connected to a water supply line for automatically dispersing water to the root system of the plant as needed by the plant, comprising:
a water tank having an upper end, an opposite lower end, and a continuous cylindrical sidewall with the continuous sidewall defining an internal water holding chamber;
a circular floor located at the lower end;
a cap mounted to the upper end and removably securable therefrom;
an elongated stem mounted to and extending downwardly from the circular floor with the elongated stem in flow registration with the water holding chamber of the water tank;
the stem having a lower end and the lower end having a drain hole through which water for the plant is discharged;
a water inlet mounted to the sidewall of the water tank adjacent the upper end and in flow communication with the water holding chamber of the water tank and to which the water supply line is connected for providing water to the water tank;
a float switch disposed in the water holding chamber adjacent the upper end for automatically dispersing water to the root system of the plant as needed by the plant; and
the float switch responsive to the amount and level of water held within the water holding tank so that the water holding tank is maintained with a constantly full amount of water thereby conserving water and avoiding water wastage.
